(19) United States
(12) Patent Application Publication
(10) Pub. No.: US 2023/0291632 A1
(43) Pub. Date: Sep. 14, 2023

(54) METHODS AND APPARATUS FOR SIGNAL MODULATION USING LATTICE-BASED SIGNAL CONSTELLATIONS

(71) Applicant: Rampart Communications, Inc., Annapolis, MD (US)

(72) Inventors: Matthew Brandon ROBINSON, Millersville, MD (US); Stephen Douglas MACKES, Crofton, MD (US)

(73) Assignee: Rampart Communications, Inc., Annapolis, MD (US)

(21) Appl. No.: 18/112,330

(22) Filed: Feb. 21, 2023

Related U.S. Application Data
(60) Provisional application No. 63/312,496, filed on Feb. 22, 2022.

(51) Int. Cl. H04L 27/34

(52) U.S. Cl. CPC H04L 27/3416

(57) ABSTRACT

A data modulation method includes receiving a bit string at a processor, and identifying a set of binary strings based on the bit string. Each binary string from the set of binary strings is mapped to an element from a set of elements of a lattice-based signal constellation, without using a lookup table. Real-valued points from the set of elements are identified based on the mapping. The method also includes causing transmission of a signal having a modulation based on the real-valued points.

### CROSS-REFERENCE TO RELATED APPLICATIONS

This application claims priority to and the benefit of U.S. Provisional Pat. Application No. 63/312,496, filed Feb. 22, 2022 and titled “METHODS AND APPARATUS FOR SIGNAL MODULATION USING LATTICE-BASED SIGNAL CONSTELLATIONS,” the contents of which are incorporated by reference herein in their entirety.

### FIELD

The present disclosure relates to signal processing for communication systems, and more specifically, to lattice-based data modulation methods.

### BACKGROUND

A lattice is a periodic arrangement of points in an n-dimensional space. Communications engineers and information theorists use lattices for quantization and modulation, for example to perform lossy compression (“source coding”) and/or noise immunity (“channel coding”).

### SUMMARY

In some embodiments, a data modulation method includes receiving a bit string at a processor, and identifying a set of binary strings based on the bit string. Each binary string from the set of binary strings is mapped to an element from a set of elements of a lattice-based signal constellation, without using a lookup table. Real-valued points from the set of elements are identified based on the mapping. The method also includes causing transmission of a signal having a modulation based on the real-valued points.

In some embodiments, a data demodulation method includes receiving at a processor and from a transmitter, a signal encoding a bit string. A point of an n-dimensional lattice associated with the signal is identified, via the processor, based on the signal and a closest vector algorithm. The point of the n-dimensional lattice is multiplied, via the processor, by an inverse of a basis of the n-dimensional lattice, to identify an element from a plurality of elements of an n-dimensional matrix ℤⁿ associated with the signal. Bits are recovered based on the signal, via the processor, by reducing components of the signal modulo m, to produce an element of a quotient ℤⁿ/mℤⁿ.

### BRIEF DESCRIPTION OF THE DRAWINGS

FIG. 1 is a diagram of a lattice-based data modulation system, according to an embodiment.

FIGS. 2-6 show various aspects of constellation diagrams, illustrating various aspects of the present disclosure, in accordance with some embodiments.

FIG. 7 is a flowchart illustrating a lattice-based data modulation method, according to an embodiment.

FIG. 8 is a flowchart illustrating a lattice-based data demodulation method, according to an embodiment.

FIG. 9 is a plot of probabilities for error bounds associated with Leech lattices, according to an embodiment.

FIG. 10 shows an example hexagonal lattice, for use in data modulation / demodulation, in accordance with one or more embodiments.

FIG. 11 shows shaping region vs. shape gain tradeoff curves, for different values of N associated with an N-dimensional shaping region, in accordance with one or more embodiments.

### DETAILED DESCRIPTION

Vast literature exists on modulation techniques for wireless communications. One related area of research is in using various types of dense packings and/or (generally regular) lattices to modulate data into higher dimensional spaces. These ideas go back to the original work of Claude Shannon (see, e.g., Shannon, Claude E., “Probability of Error for Optimal Codes in a Gaussian Channel,” Bell System Tech. J. 38, 611-656) and the Shannon-Hartley theorem, and research continues through today.

One known idea within the wireless communications community is to use points in higher dimensional spaces that are more “dense” than the usual quadrature amplitude modulation / amplitude and phase-shift keying (QAM/APSK) constellations. This allows greater distance (e.g., Hamming distance or Euclidean distance) between the constellation points, which decreases the probability that channel noise or other channel distortions will cause an error. There have also been many attempts to combine coding theory with modulation, such as trellis coded modulation and multilevel codes

Most of the foregoing approaches use either a coding theoretic construction (e.g., one of the approaches discussed in Conway, J and Sloane, N, “Sphere Packings, Lattices, and Groups, Springer, 1993) or a lattice constellation without underlying coding.

Known coding theoretic construction approaches typically include breaking a lattice, or a set of lattices, into a set of lattice cosets. A set of coded bits is then used to select a coset (as a subset of the lattice or set of lattices), and a set of uncoded bits is used to select a point within the subset. For example, a set of message bits may be run through a standard (binary) error correcting code (e.g., a convolutional encoder), and the output (encoded) bits are used to select a coset. The remaining message bits are then used to select a point within that coset.

Another known approach is to use a lattice constellation without underlying coding, but instead to use an elaborate series of lookup tables (which becomes intractable at higher throughputs/larger constellations), or to use more geometrically convenient shaping regions such as rectangles (which reduce the efficiency of the constellations).

In contrast to the foregoing known techniques, some embodiments of the present disclosure facilitate bit-to-symbol mapping and symbol-to-bit mapping for a lattice based constellation, for example in a modem / baseband processor and for mapping bits into complex baseband I/Q points, irrespective of any underlying coding theoretic schemes, and without singling out closest elements of the lattices. Moreover, embodiments of the present disclosure do not use lookup-tables to map bit strings to lattice points, or to subsets of lattice points. Still further, in some implementations, embodiments of the present disclosure do not use rectangular shaping regions.

As used herein, a lattice can refer to a set of points in an n-dimensional space given by all linear combinations with integer coefficients of a basis set of up to n linearly independent vectors. One example of a lattice is a Leech lattice, discussed further below. As used herein, a Voronoi region of a lattice point can refer to the region of the n-dimensional space closer to that lattice point than to all other lattice points. A code is a finite set of codewords having a specified length, a codeword being a sequence of symbols encoding a message to be transmitted within a communication system. Codewords are translated into signals (coded signals) via modulation to real and/or complex values. Coded signals can be represented as points within a signal space. A lattice code is defined by a finite set of lattice points within a predefined region of a given lattice, the predefined region referred to herein as a “shaping region.”

Consider an ordered basis B for an n-dimensional lattice Λⁿ. The basis is an isomorphism from Zⁿ (an n-dimensional vector of integers) to points of Λⁿ. Furthermore, note that B restricts to an isomorphism of subgroups λℤⁿ→ λΛⁿ for λ ∈ ℤ. Illustrating this below, notice that since the square on the left side of the diagram commutes, the composition of the basis with the quotient map Q has kernel (“ker”) λℤⁿ (i.e., ker(Q ∘ B) = λℤⁿ). Now, by the universal property of cokernels, there exists a unique homomorphism, σ:ℤⁿ/λℤⁿ → Λⁿ/λΛⁿ that makes the square on the right commute.

$$\begin{matrix}{ℤ}^{n} & {\to }^{λ} & {ℤ}^{n} & {\to }^{} & {ℤ}^{n} / λ {ℤ}^{n} \\ B ↓ & & B ↓ & & σ ↓ \\ {\text{Λ}}^{n} & {\to }^{λ} & {\text{Λ}}^{n} & {\to }^{Q} & {\text{Λ}}^{n} / λ {\text{Λ}}^{n}\end{matrix}$$

By employing the same strategy using B⁻¹, a map τ:Λⁿ/λΛⁿ→ℤⁿ/λℤⁿ is obtained, which makes the right side commute. Therefore, τ = σ⁻¹, making σ an isomorphism. So, the quotient λⁿ/λΛⁿ is isomorphic as an abelian group to the quotient ℤⁿ/λℤⁿ. The space ℤⁿ/λℤⁿ is the set of n copies of integers modulo λ (i.e., of the form (a₁, a₂, a₃, ..., aₙ), where each aᵢ ∈ (0...,λ-1). This size of this set is λⁿ. And, because of the isomorphism implied by the above commutative diagram, the size of Λⁿ/λΛⁿ is also λⁿ.

If the value of λ is taken to be a power of 2 (such that λ = 2^{k}), then the number of points in the quotient Λⁿ/λΛⁿ is 2^{nk}. This means that there is a bijection from binary strings (or sub-strings) of length nk to the elements of the quotient Λⁿ/λΛⁿ.

As an explicit construction of this bijection, consider the set of 2^{nk} strings of nk bits. If any given bit string is broken into blocks or sub-strings of k bits, each k-bit sub-string can be naturally mapped to the integers mod λ by treating that k-bit sub-string as the binary expansion of the integer. In this way, each of the length-nk bit strings is mapped to ℤⁿ/λℤⁿ - n values taken from the integers mod λ = 2^{k}. So, given a length-nk bit string, mapped to an element α ∈ ℤⁿ/λℤⁿ, a point of the lattice Λ can be produced using the basis. Specifically, the point of the lattice will be p= Bα ∈ Λⁿ.

The point p can be reduced to an enlarged Voronoi cell at the origin by subtracting the point of λΛⁿ that is closest to p, resulting in a point q ∈ Λⁿ/λΛⁿ.

One subtlety that may arise is that the fundamental/Voronoi region of λΛⁿ may pass through some of the points of Λⁿ. Suppose that a point x ∈ Λⁿ intersects the fundamental region of λΛⁿ. By the group property of lattices, this means that -x also intersects the fundamental region of λΛⁿ. As used herein, a “fundamental region” refers to a Voronoi cell of the origin, or a lattice region in which every point is closer to the origin than to any other lattice point. If x = Bα, then by linearity, the point that produces -x is -α. But both α and -α are both elements of ℤⁿ/λℤⁿ.

As an illustration of this, let n = 2 and let k = 1, and let the lattice basis B have basis vectors (1,1) and (1,-1), so the matrix is B =

$$\left(\begin{matrix}1 & 1 \\ 1 & - 1\end{matrix}\right)$$

The set of valid α vectors is (0,0), (0,1), (1,0), and (1,1). B maps these, respectively, to (0,0), (1,-1), (1,1), and (2,0). However, consider the additive inverse of the three non-zero α vectors - (0,-1), (-1,0), and (-1,-1). B maps these, respectively, to (-1,1), (-1,-1), and (-2,0). However, the points (0,-1) and (0,1) are equivalent modulo 2, as are the points (-1,0) and (1,0), and the points (-1,-1) and (1,1). So, for the points that lie on the surface of the fundamental region of λΛⁿ, there is an ambiguity.

The ambiguity can be resolved by creating a convention for the selection of points to be used. This convention can include, for example, selecting a face of a fundamental region to be used, and then only using the point on that (selected) face. Alternatively, the convention can include slightly shifting the fundamental region away from the origin, to “break” the symmetry that resulted in points on the fundamental region surface. For example, slightly shifting the fundamental region (i.e., resulting in a “shifted fundamental region”) can refer to shifting the fundamental region by a smallest amount (and in an appropriate direction) that prevents any points from intersecting the enlarged fundamental region.

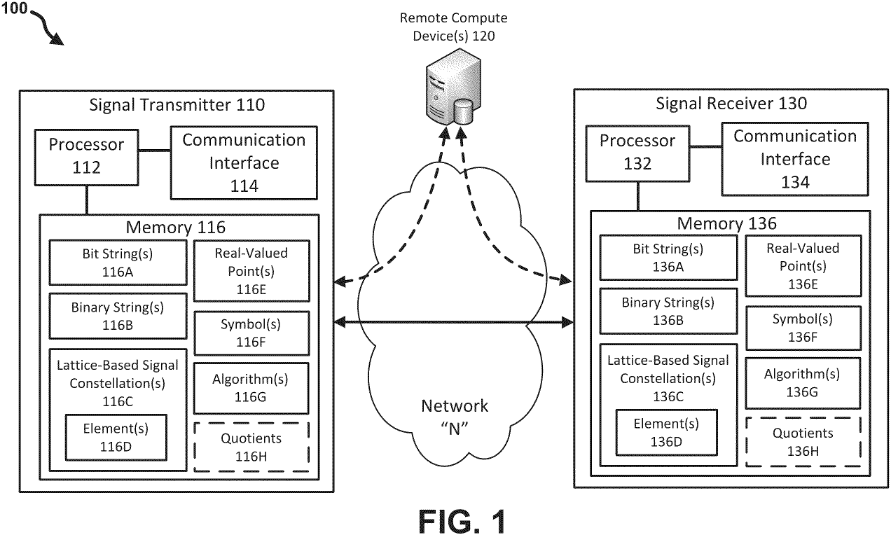

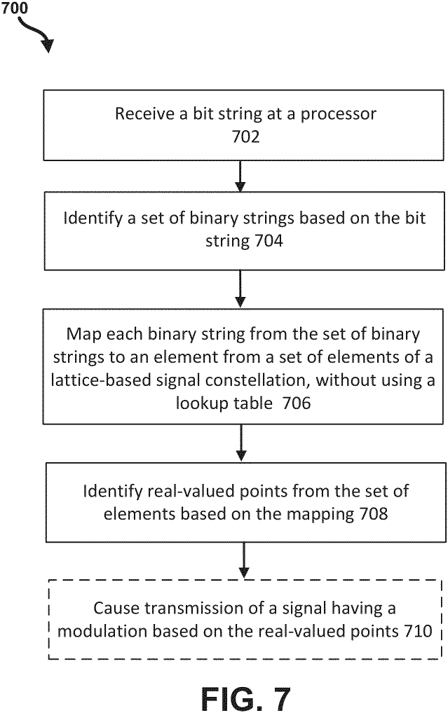

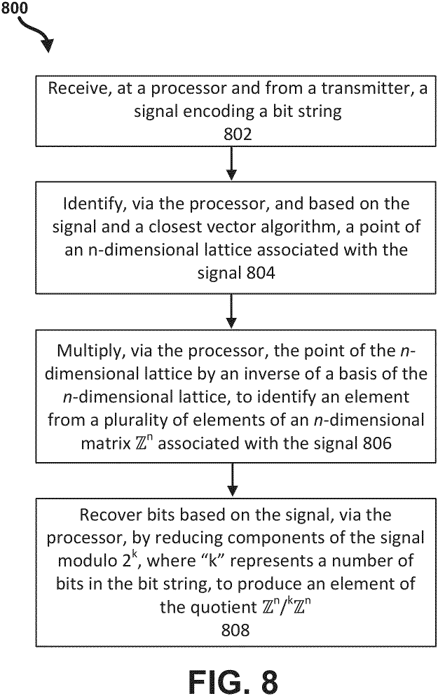

Turning now to the drawings, FIG. 1 is a diagram of a lattice-based data modulation system, according to an embodiment. The lattice-based data modulation system 100 can be used, for example, for remediating signal distortion by correcting timing and frequency offsets. As shown in FIG. 1, the lattice-based data modulation system 100 includes a signal transmitter 110 in communication (e.g., via a wired or wireless communications network “N”) with a signal receiver 130. Optionally, one or both of the signal transmitter 110 and signal receiver 130 is also in communication (e.g., via a wired or wireless communications network “N”) with one or more remote compute devices 120 (e.g., for remote storage of data). The signal transmitter 110 includes a processor 112 operably coupled to a communications interface 114 and to a memory 116. The memory 116 stores data and/or processor-executable instructions (e.g., to perform method 700 of FIG. 7, as discussed below). For example, as shown in FIG. 1, the memory 116 includes bit strings 116A, binary strings 116B, lattice-based signal constellations 116C (including lattice elements 116D), real-valued points 116E, symbols 116F, algorithms 116G (e.g., one or more closest vector algorithms), and optionally quotients 116H. Similarly, the signal receiver 130 includes a processor 132 operably coupled to a communications interface 134 and a memory 136. The memory 136 stores data and/or processor-executable instructions (e.g., to perform method 800 of FIG. 8, as discussed below). For example, as shown in FIG. 1, the memory 136 includes bit strings 136A, binary strings 136B, lattice-based signal constellations 136C (including lattice elements 136D), real-valued points 136E, symbols 136F, algorithms 136G (e.g., one or more closest vector algorithms), and optionally quotients 136H.

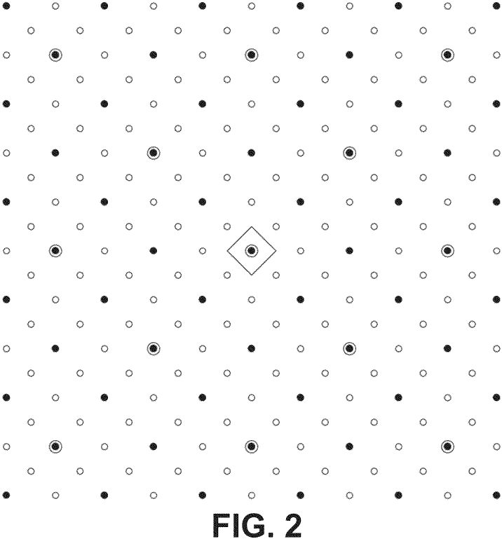

To illustrate the procedures discussed above, consider the constellation diagrams shown in FIGS. 2-6. of FIG. 2 shows the lattice generated by the B matrix given above. Every dot in this diagram represents a point of the lattice A². The empty circles represent points that are only in A². The filled in dots are points in both A² and 2Λ². The filled in dots with a circle around them are in Λ², 2Λ², and 4λ². The diamond at the center of the diagram represents the fundamental region of A² (taking the point at the center of the diamond as the origin). In this example, n=2 (i.e., a 2-dimensional lattice).

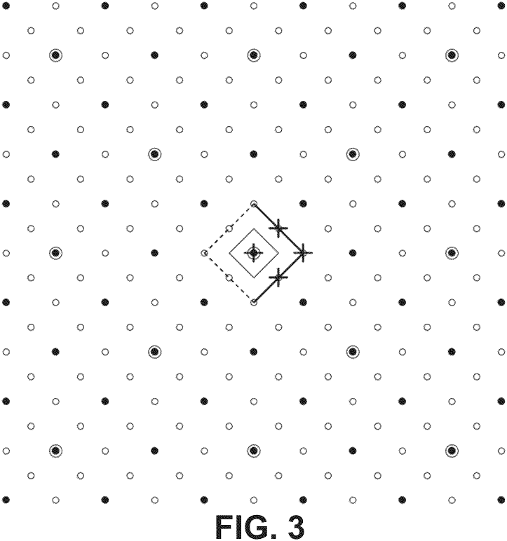

By taking k=1, the fundamental region of 2A² can be included, as shown in FIG. 3. Two of the sides of the fundamental region are drawn with solid lines, and the two opposite sides are drawn with dashed lines. The diagram of FIG. 3 illustrates the implementation of a convention in which only (1) points that are either entirely inside the fundamental region, and (2) points that are on the surface if and only if the points intersect a solid line, are included. The λⁿ =(2^{k})ⁿ=(2¹)² = 4 points that are selected by this convention are shown with plus (+) symbols drawn over them. These 4 points are the lattice points that will be used in bit-to-symbol mapping.

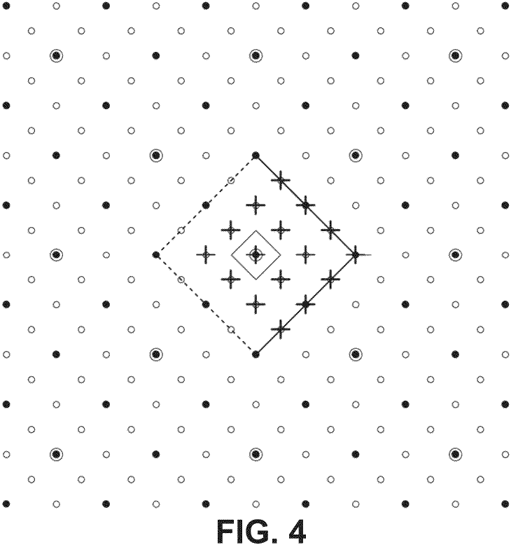

Similarly, for k=2, the fundamental region of 4Λ² can be drawn, and a convention similar to the convention applied in FIG. 3 can be used, as shown in FIG. 4. In the diagram of FIG. 4, the λⁿ =(2^{k})ⁿ=(2²)²= 16 points that are selected for use in data modulation are represented by a plus (+). In other words, these 16 points are the lattice points that will be used in bit-to-symbol mapping.

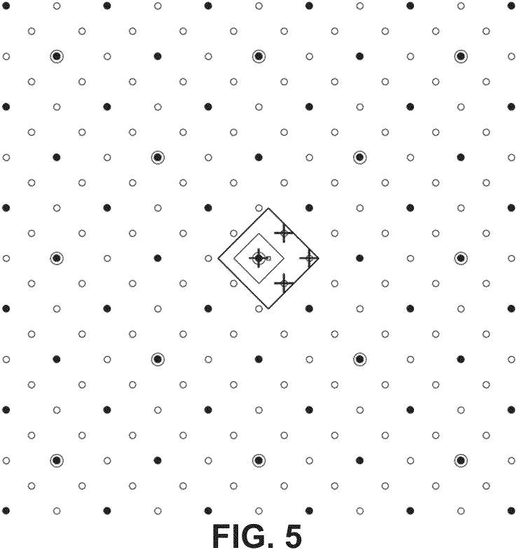

In other embodiments, the fundamental region may be shifted, as shown in FIG. 5 for k=1. A small diamond (square rotated 45°) is shown at the center point of the fundamental region of 2Λ², and the 4 selected points are marked with a plus (+).

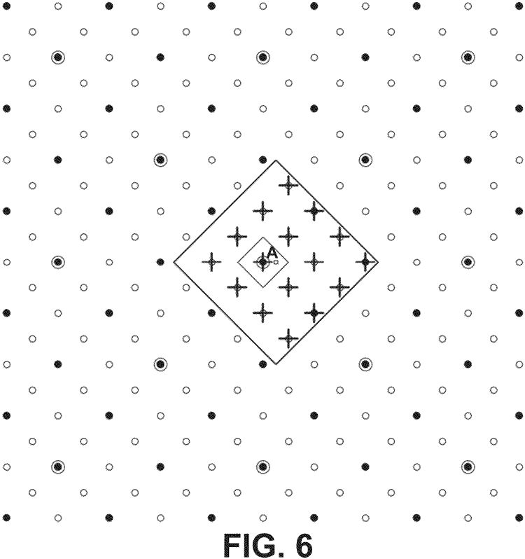

Similarly, as shown in the embodiment of FIG. 6, for k=2, the fundamental region may be shifted, and the 16 points selected for use in data modulation marked by a plus (+).

In some implementations, when using a small offset from the origin to produce the 2^{nk} points, it can be advantageous to shift each point of a fundamental region to make the dot labelled “A” the actual center of the set of points, so that the set of all data points has zero mean. The offset is a single vector in Euclidean space (ℝₙ), and is not made of lattice points.

In some embodiments, a data modulation method includes performing a bit-to-symbol mapping that uses a lattice constellation.

In some embodiments, a data demodulation method includes performing a symbol-to-bit mapping that uses a lattice constellation.

In some embodiments, a lattice-based data modulation method or demodulation method does not include lattice coding, and does not include the use of redundant lattice points.

In some embodiments, a data modulation method or demodulation method includes using a quotient of a lattice with a copy of that lattice scaled by a positive integer.

In some embodiments, a data modulation method includes mapping 2^{nk} binary strings (of length nk) to elements of a quotient Λⁿ/2^{k}Λⁿ, or to a shifted copy (e.g., as discussed and shown with reference to FIG. 5) of said quotient. This can be performed by first mapping each length nk binary string to an element α ∈ ℤⁿ/λℤⁿ, then using the lattice basis B to produce a point Bα ∈ Λⁿ. Then, the closest point to Bα in 2^{k}Λⁿ is determined via a selected closest vector algorithm (e.g., selected prior to use of the closest vector algorithm), and that closest point is subtracted from Bα. The resulting point is guaranteed to be in the fundamental region of 2^{k}Λⁿ (or, equivalently, in Λⁿ/2^{k}Λⁿ). The real-valued points into which the bits are mapped can then be used as the in-phase and quadrature components of a signal at baseband. In some implementations, the real-valued points are the same as the closest points to Bα in 2^{k}Λⁿ. Alternatively or in addition, given a set of points (e.g., the 16 points shown in FIG. 6), all of the points will be used in the modulation scheme. For example, 8 of the points may be used for the in-phase component of the signal and the remaining 8 points may be used for the quadrature component of the signal. Alternatively or in addition, the mapping of the 2^{nk} binary strings to the elements of the quotient Λⁿ/2^{k}Λⁿ (or to the shifted copy of said quotient) is performed without using a rectangular shaping region. Alternatively or in addition, the mapping of the 2^{nk} binary strings to the elements of the quotient Λⁿ/2^{k}Λⁿ (or to the shifted copy of said quotient) is not based on lattice coding.

The real-valued points can then be transmitted (optionally with any of: upsampling, filtering, driving to carrier, sending through a digital-to-analog converter (DAC), etc.), and received by a recipient. The receiver may then perform synchronization and/or equalization. To demodulate / recover the bits, the receiver will then use the pre-selected closest vector algorithm to recover the “closest” point of Λⁿ, and this recovered closest point is either multiplied by the inverse B⁻¹, thereby producing an element of ℤⁿ, or it is used to recover soft information about the received value which can then be fed into an error correction scheme. The individual components (i.e., the elements of ℤⁿ) are then reduced mod 2^{k} (i.e., modular arithmetic is performed on the individual components), to produce an element of ℤⁿ/2^{k}ℤⁿ (or, stated more generally, ℤⁿ/mℤⁿ, where m is a positive integer). If the quotient involves an ambiguity resulting from points of Λⁿ that lie on the surface of the fundamental region of 2^{k}Λⁿ, the ambiguity may be resolved (e.g., as discussed above), for example, by enforcing a convention that selects a set of “faces” of the fundamental region to use. Alternatively, the ambiguity can be resolved by enforcing a convention that includes centering the fundamental region of 2^{k}Λⁿ around a point located away from the origin that does not result in elements of Λⁿ that lie on a surface of its fundamental region (as discussed above in reference to FIGS. 5 and 6). If the shift away from the origin is used, then the resulting constellation may be shifted by a constant vector to ensure it has a zero mean.

FIG. 7 is a flowchart illustrating a lattice-based data modulation method, according to an embodiment. As shown in FIG. 7, the method 700 includes receiving, at 702, a bit string at a processor, and identifying, at 704, a set of binary strings based on the bit string. Each binary string from the set of binary strings is mapped, at 706, to an element from a set of elements of a lattice-based signal constellation, without using a lookup table. Mapping binary strings to the elements of the lattice-based signal constellation, without using a lookup table is advantageous for at least the reason that, as discussed above, the use of lookup tables can become intractable at higher throughputs and/or for larger constellations. Real-valued points from the set of elements are identified at 708 based on the mapping. The method 700 also includes causing transmission of a signal having a modulation based on the real-valued points at 710.

In some implementations, the real-valued points represent in-phase/quadrature (I/Q) points or components.

In some implementations, the set of elements is associated with a quotient of a first lattice and a second lattice, the second lattice being a copy of the first lattice scaled by a positive integer.

FIG. 8 is a flowchart illustrating a lattice-based data demodulation method, according to an embodiment. As shown in FIG. 8, the method 800 includes receiving, at 802, at a processor and from a transmitter, a signal representing a bit string. A point of an n-dimensional lattice associated with the signal is identified at 804, via the processor, based on the signal and a closest vector algorithm. The point of the n-dimensional lattice is multiplied, at 806 and via the processor, by an inverse of a basis of the n-dimensional lattice, to identify an element from a plurality of elements of an n-dimensional matrix ℤⁿ associated with the signal. Bits are recovered at 808 based on the signal, via the processor, by reducing the I/Q points of the signal modulo m (e.g., 2^{k}, where “k” represents a number of bits in the bit string), to produce an element of a quotient ℤⁿ/mℤⁿ (e.g., ℤⁿ/2^{k}ℤⁿ).

In some implementations, the method also includes performing at least one of synchronization or equalization of the signal prior to identifying the point of an n-dimensional lattice associated with the signal.

In some implementations, the point is a first point, and the method also includes identifying, via the processor, an ambiguity associated with the quotient ℤⁿ/mℤⁿ. In response to identifying the ambiguity, a set of faces of a fundamental region of the n-dimensional lattice can be selected via the processor, and a second point of the n-dimensional lattice associated with the signal can be identified via the processor based on the set of faces of a fundamental region of the n-dimensional lattice, the instructions to recover the bits including instructions to recover the bits further based on the second point.

In some implementations, the point is a first point, and the method also includes identifying, via the processor, an ambiguity associated with the quotient ℤⁿ/mℤⁿ. In response to identifying the ambiguity, a fundamental region of the n-dimensional lattice is centered around a second point of the n-dimensional lattice that is distanced from an origin of the n-dimensional lattice, such that the plurality of elements of the n-dimensional matrix ℤⁿ do not lie on a surface of the fundamental region.

### Leech Lattices

Some embodiments of the present disclosure improve upon known communications techniques using Leech lattices as the basis for a lattice-based signal constellation. The Leech lattice is an even unimodular lattice A24 in 24-dimensional Euclidean space, and is an attractive candidate. The following discussion quantifies the gain achievable by Leech lattices, as contrasted with some known constellations, assuming spherical shaping regions, which are approximated, in some instances, using a scaled Voronoi as described herein.

The Leech lattice is expected to have some interesting communication capabilities. Consider the set of points (also referred to herein as “centers”) of Λ contained within and on a sphere of radius 4√n for some fixed positive integer n, and denote this set by Λⁿ i.e., Λⁿ =

$${∪}_{i = 1}^{n} {Λ}_{i} .$$

Each point can serve as a signal vector. Those signals in Λⁿ are referred to herein as surface vectors, and the others are referred to herein as internal vectors of Λⁿ. The decision region for an internal vector is bounded by 196,560 hyper-planes, which makes it unlikely that an exact expression for the probability of error will be found. An upper bound for the probability of error and/or a lower bound for the probability of error, however, can be found.

Assume that all signals are equally likely, and consider the probability of error given that an internal vector was sent. Further, assume that the channel has the effect of additively perturbing each signal component independently by a gaussian random variable of mean zero and variance N₀/2. The probability of a correct decision P(C) is greater than the probability that the perturbed vector remains within a sphere of radius 2√2 about the sent signal vector. To calculate this probability, denote the twenty-four dimensional gaussian distribution of independent variates, each with mean zero and variance N₀/2, by:

$$ρ \left(x\right) = exp \left[- {\left|x\right|}^{2} / {N}_{0}\right] / {\left(π {N}_{0}\right)}^{12} .$$

A sphere of radius r in E₂₄ has a surface area:

$$S \left(r\right) = \frac{2 ⋅ {π}^{12}}{\text{Γ} \left(12\right)} {r}^{23} .$$

Thus, the probability of the signal vector remaining inside a sphere of radius 2√2 is

$$\begin{matrix}= {\int }_{0}^{2 \sqrt{2}} S \left(r\right) p \left(\left|x\right| = r\right) d r \\ = \frac{2}{\text{Γ} \left(12\right)} {\left(\frac{1}{{N}_{0}}\right)}^{12} {\int }_{0}^{2 \sqrt{2}} {r}^{33} exp \left(- {r}^{2} / {N}_{0}\right) d r\end{matrix}$$

By the change of variable y = r²/N₀ this last expression may be written as:

$$\frac{1}{\text{Γ} \left(12\right)} {\int }_{0}^{8 / {N}_{0}} {y}^{11} {e}^{- y} d y = P \left(12 , 8 / {N}_{0}\right) ,$$

where P(a, x) is the incomplete gamma function. The probability of a correct decision for a surface vector will be slightly greater than this quantity. Here, the region of integration is over the same sphere as above, plus a conical region exterior to the sphere of radius 2√n. The integration over the conical region may be expressed in terms of a double integral that may be complex to compute, and that may be small except at very high noise levels. For simplicity, this term may be ignored. Hence, a bound on the probability of error P_{L}(E) for the subset of the Leech Lattice Λⁿ is given by:

$${P}_{L} \left(E\right) < 1 - P \left(12 , 8 / {N}_{0}\right) ,$$

which may be written as:

$${P}_{L} \left(E\right) < {e}_{11} \left(8 / {N}_{0}\right) exp \left[- 8 / {N}_{0}\right] , \qquad \text{(1)}$$

where

$${e}_{11} \left(x\right) = {\sum }_{i = 0}^{11} \frac{{x}^{i}}{i !} .$$

The signal vectors of Λⁿ are energy constrained by:

$${E}_{8} = 24 {E}_{N} ≼ 16 n ,$$

and so E_{N} = (16/24)n = 2n/3, where E_{N} is the energy per dimension and the subscript N is 24. Thus, in the upper bound (1),

$$\frac{8}{{N}_{0}} = \frac{{E}_{N}}{{N}_{0}} \frac{12}{n} .$$

Compare the bound (1) to the bound P_{G}(E), for signals constrained in energy by 24E_{N}:

$$P \text{} \_ \text{} G \left(E\right) < B exp \left[- N \left\{\left(1 - β + \frac{1}{2} 1 n \left(β + \frac{{E}_{N}}{2 {N}_{0}}\right) - R\right)\right\}\right] , \qquad \text{(2)}$$

$$R < \frac{1}{2} 1 n \left(1 + \frac{2 {E}_{N}}{{N}_{0}}\right) ,$$

where

$$B = 24 π {e}^{2} \left(1 - {β}^{2}\right)$$

and

$$β = \frac{1}{2} \left[1 - \frac{{E}_{N}}{{N}_{0}} + {\left(1 + {\left(\frac{{E}_{N}}{{N}_{0}}\right)}^{2}\right)}^{1 / 2}\right] .$$

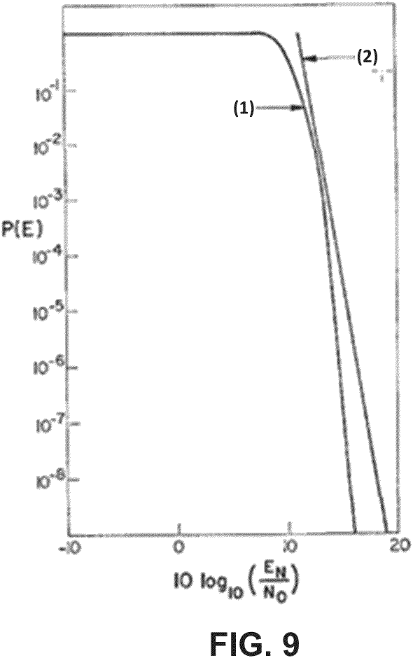

The probabilities for the two error bounds (1) and (2) are plotted in FIG. 9 for n = 10 or, equivalently, for R = 1.2597, where:

$$R = \frac{1}{24} l o {g}_{e} M ,$$

M being the number of signals. The curves are labelled by their equation numbers. Notice that only certain rates are possible with the Leech Lattice. As can be seen in FIG. 9, the upper bound for the Leech Lattice is lower than Gallagers bound, for n = 10.

For large values of

$${E}_{n} / {N}_{0} \left({E}_{N} / {N}_{0} > 10\right) , β \to \frac{1}{2}$$

and Gallagers bound behaves as:

$$K {\left({E}_{N} / {N}_{0}\right)}^{- 12} , \qquad \text{(3)}$$

where K is a constant. The bound for Λⁿ in (1) behaves as

$${K}^{′} {\left(\frac{{E}_{N}}{{N}_{0}}\right)}^{11} e x p \left[- \frac{{E}_{N}}{{N}_{0}} \frac{12}{10}\right] ,$$

which gives exponential decrease rather than n-th power. This is reflected in the behaviour of the curves of FIG. 9.

The two bounds behave in approximately the same manner for other values of n. Consider the effect of the change from n = 10 to n = 100. Using the asymptotic value for the number of points in Λ¹⁰⁰, one obtains:

$${R}^{′} = 2.38870.$$

The effect on the bound (1) is merely to shift the curve to the right by 10 db. The effect on bound (2) is to multiply values for n = 10 by e^{NΔR} = e^{24x1.1290} = e^{27.096} = 5.852 × 10¹¹. For values of E_{N/}N₀ such that 10 log₁₀(E_{N/}N₀) > 10, i.e., E_{N/}N₀ > 10, the behaviour indicated by Eq. (3) becomes a very good approximation. On the logarithmic scales used in the figure, this implies that the bound (2) will be very close to a straight line. Using this straight line approximation to the bound, it may be seen that multiplication by 5.852 × 10¹¹ is equivalent to a right shift of the bound by an amount slightly greater than 10 db.

Note that the bound (2) is valid only for

$$R < \frac{1}{2} 1 n \left(1 + 2 {E}_{N} / {N}_{0}\right)$$

which implies, for n = 10 and R = 1.2597, that the bound is valid only for:

$$10 l o {g}_{10} \left({E}_{N} / {N}_{0}\right) > 7.5686.$$

Attempts were made, without success, to find a reliability or exponent function for the bound of (1).

### Euclidean Codes

A Euclidean code is a finite set of points x₁, ..., x_{M} in n-dimensional real Euclidean space Rⁿ. Euclidean codes can be used as signal sets for a Gaussian channel, as representative points (or output vectors) in a vector quantizer, and in many other applications. There are a number of desirable properties that a Euclidean code should have:
1) the number M of code vectors should be large;
2) the total energy ∑∥xᵢ∥² (or alternatively the peak energy max ∥xᵢ∥² ) should be small;
3) the minimum distance between the xᵢ should be large (or alternatively the probability of incorrect decoding should be small, if the code is used on a Gaussian channel);
4) given k, it should be possible to readily find the k th code vector xₖ;
5) given xₖ, it should be possible to readily find its index k; and
6) given an arbitrary point z ∈ Rⁿ, it should be possible to readily find the closest code vector xₖ.

The foregoing properties (also referred to herein as “problems” to solve) are not necessarily independent of one another, and there may be tradeoffs between / among them. Lattice codes include a subset of points of some lattice in Rⁿ, which is a set of points of a lattice packing of equal n-dimensional spheres. The code is defined by specifying a lattice A in Rⁿ and a certain region of the space Rⁿ, and consists of all lattice points inside this region.

For these codes, the minimum distance is the minimum distance between lattice points, and the number of code vectors is determined by the density of the lattice. Thus, properties 1) and 3) amount to saying that the lattice should have a high density, and property 2) states that the region of space defining the code should be as nearly spherical as possible.

Some known very fast algorithms have been used to satisfy property 6) for a large class of lattice codes. According to some embodiments of the present disclosure, similar lattices are used to satisfy properties 4) and 5). Since if the codes are used for a Gaussian channel 6) is the decoding problem while 4) and 5) are encoding problems, properties 4) and 5) might be expected to be more readily solved than property 6). For these codes, however, properties 4), 5), and 6) appear to be of comparable difficulty.

In accordance with some embodiments, to solve for properties 4) and 5), only lattice codes that are defined by certain very special regions of space, regions that can be called Voronoi-shaped, are considered, and such regions are referred to herein as Voronoi codes.

Voronoi codes can have the following two drawbacks: only certain rates can be attained, and because the Voronoi-shaped regions defining them are not spherical, they do not in general have the lowest possible total energy (although the difference may be small). Under the notation set forth herein, the norm ||x||² of a vector x is its squared length x • x.

### Encoding Algorithm to Solve Problem 4): Finding a Code Vector From its Index

Given an index vector (k₁, ..., kₙ) with

$$0 ⩽ {k}_{i} r ⩽ - 1 ,$$

suppose one desires to find that vector x in the Voronoi code C_{Λ}(r, α) for which index (x) = (k₁, ..., kₙ). To do so, first form x′ = ∑kᵢvᵢ, which has index equal to (k₁, ..., kₙ) but need not be in the code. The desired lattice point x is then the unique solution to:

$$x ≡ {x}^{′} \left(mod r \text{Λ}\right) , x ∈ a + {V}_{r} \qquad \text{(4)}$$

(by the definition of C_{Λ}(r, α)). Equation (4) is readily solved if there is an algorithm available for solving for property 6), i.e., for finding the closest point of A to an arbitrary point of the space. In fact, if one sets z = r⁻¹(x′ - α), and λ is the closest point of A to z, then x = x′ - rλ is the desired lattice point. Thus, property 4) may be solved as follows.

Given the index vector (k₁, ..., kₙ), calculate x′ = ∑kᵢvᵢ and z = r⁻¹(x′ - a). Find the closest point λ ∈ Λ to z (using, for example, the algorithms in [3]). Then x = x′ - rλ - a is in the Voronoi code C_{Λ}(r, a) and has index (k₁, ..., kₙ).

For example, consider a four-dimensional Voronoi code C_{D}_{₄}(4, α) obtained from a D₄ lattice. Suppose the given index vector is (2, 0, 0, 1). Next, calculate:

$$\begin{matrix}{x}^{′} = \left(5 , 0 , 0 , 1\right) , \\ z = \frac{1}{4} \left(5 , - \frac{3}{16} , - \frac{11}{32} , \frac{15}{32}\right) \\ = \left(1.25 , - 0.05 ⋯ , - 0.09 ⋯ , 0.12 ⋯\right) \\ \text{λ} = \left(2 , 0 , 0 , 0 , 0\right) , \text{and} \\ x = \left(- 3 , 0 , 0 , 1\right) - a .\end{matrix}$$

### Finding the Closest Point of an n-Dimensional Integer Lattice ℤⁿ

In accordance with some embodiments, an algorithm for finding the closest point of the integer lattice ℤⁿ to an arbitrary point x ∈ ℝⁿ is used. For a real number x, let:

$$f \left(x\right) = \text{closest integer to} x .$$

In case of a tie, choose the integer with the smallest absolute value. For x = (x₁, · · ·, xₙ ) ∈ ℝⁿ, let

$$f \left(x\right) = \left(f \left(x 1\right) , ⋯ , f \left({x}_{n}\right)\right) .$$

Also define g(x), which is the same as ƒ(x) except that the worst component of x-that furthest from an integer-is rounded the wrong way. In case of a tie, the component with the lowest subscript is rounded the wrong way. More formally, for x ∈ ℝ,ƒ(x) and the function w(x), which rounds the wrong way, are defined as follows. (Here, m is an integer.)

$$\begin{matrix}\text{If} x = 0 , \text{then} f \left(x\right) = 0 , \\ w \left(x\right) = 1. \\ \text{If} 0 < m \leq x \leq \text{m} + \frac{1}{2} , \text{then} f \left(x\right) = m , \\ w \left(x\right) = m + 1. \\ \text{If} 0 < m + \frac{1}{2} < x < \text{m} + 1 , \text{then} f \left(x\right) = \text{m} + 1 , \\ w \left(x\right) = m . \\ \text{If} - m - \frac{1}{2} \leq x \leq - \text{m} < 0 , \text{then} f \left(x\right) = - m , \\ w \left(x\right) = - \text{m} - 1. \\ \text{If} - m - 1 < x < - \text{m} - \frac{1}{2} , \text{then} f \left(x\right) = - m - 1 , \\ w \left(x\right) = - \text{m} .\end{matrix} \qquad \text{(5)}$$

(Ties are handled so as to give preference to points of smaller norm.) Also:

$$x = f \left(x\right) + \text{δ} \left(x\right) ,$$

so that * δ( x ) * ≤ ½ is the distance from x to the nearest integer.

Given x= (x₁, · · ·, _{Xn}) ∈ ℝⁿ, let k (1 ≤ k ≤ n) be such that:

$$∗ \text{δ} \left({x}_{k}\right) ∗ \leq ∗ \text{δ} \left({x}_{i}\right) ∗ \text{for all} 1 \leq i \leq n$$

and

$$∗ \text{δ} \left({x}_{k}\right) ∗ = ∗ \text{δ} \left({x}_{i}\right) ∗ \text{Ψ} k \leq i .$$

Then, g(x) is defined by:

$$g \left(x\right) - \left(f \left(x 1\right) , f \left(x 2\right) , ⋯ , w \left({x}_{k}\right) , ⋯ , f \left({x}_{n}\right)\right) .$$

Algorithm 1 — To Find the Closest Point of ℤⁿ to x: Given x ∈ ℝⁿ, the closest point of ℤⁿ is ƒ(x). (If x is equidistant from two or more points of ℤⁿ, this procedure finds the one with the smallest norm.)

To see that the procedure works, let u = (u₁, · · ·, uₙ) be any point of ℤₙ. Then,

$${\left‖u - x\right‖}^{2} = {\sum }_{i = 1}^{n} {\left({u}_{i} - {x}_{i}\right)}^{2} .$$

which is minimized by choosing uᵢ = ƒ(xᵢ) for i = 1, · · ·, n. Because of (5), ties are broken correctly, favoring the point with the smallest norm.

### Finding the Closest Point of Dₙ

Algorithm 2—To Find the Closest Point of Dₙ to x: Given x ∈ ℝⁿ, the closest point of Dₙ is whichever of f(x) and g(x) has an even sum of components (one will have an even sum, the other an odd sum). If x is equidistant from two or more points of Dₙ, this procedure produces a nearest point having the smallest norm.

This procedure works because ƒ(x) is the closest point of ℤⁿ to x and g(x) is the next closest. ƒ(x) and g(x) differ by one in exactly one coordinate, and so precisely one of ∑ƒ(xᵢ) and ∑g(xᵢ) is even and the other is odd. Again, (5) implies that ties are broken correctly.

Example: Find the closest point of D₄ to x (0.6, - 1.1, 1.7, 0.1). Compute:

$$f \left(x\right) = \left(1 , - 1 , 2 , 0\right)$$

and

$$g \left(x\right) = \left(0 , - 1 , 2 , 0\right) ,$$

since the first component of x is the furthest from an integer. The sum of the components of ƒ(x) is 1- 1 + 2 + 0 = 2, which is even, while that of g(x) is 0 - 1 + 2 + 0 = 1, which is odd. Therefore, ƒ(x) is the point of D₄ closest to x.

To illustrate how ties are handled, suppose:

$$\text{x} \text{=} \left(\frac{1}{2} , \frac{1}{2} , \frac{1}{2} , \frac{1}{2}\right) .$$

In fact, x is now equidistant from eight points of D₄, namely (0, 0, 0, 0), any permutation of (1, 1, 0, 0), and (1, 1, 1, 1). The algorithm computes:

$$f \left(x\right) = \left(0 , 0 , 0 , 0\right) , \text{sum} \text{=} \text{0,} \text{even,}$$

$$g \left(x\right) = \left(1 , 0 , 0 , 0\right) , \text{sum} \text{=1} \text{,} \text{odd,}$$

and selects ƒ(x). Indeed, ƒ(x) does have the smallest norm of the eight neighboring points.

### Finding the Closest Point of E₈

Since E₈ is the union of two cosets of D₈, the discussion in the previous section leads to the following procedure.

Algorithm 3—To Find the Closest Point of E₈ to x: Given x = (x₁, · · ·, x₈) ∈ ℝ⁸.

Compute ƒ(x) and g(x), and select whichever has an even sum of components; call it y₀. Compute

$$\text{f} \left(x - \frac{1}{2}\right) \text{and} g \left(x - \frac{1}{2}\right) ,$$

where:

$$\frac{1}{2} \text{=} \left(\frac{1}{2} , \frac{1}{2} , \frac{1}{2} , \frac{1}{2} , \frac{1}{2} , \frac{1}{2} , \frac{1}{2} , \frac{1}{2}\right) ,$$

and select whichever has an even sum of components; add

$$\frac{1}{2}$$

and call the result y₁.

Compare y₀ and y₁ with x, and choose the closest. For example, to find the closest point of E₈ to

$$x = \left(0.1 , 0.1 , 0.8 , 1.3 , 2.2 , - 0.6 , - 0.7 , 0.9\right) ,$$

compute

$$f \left(x\right) = \left(0 , 0 , 1 , 1 , 2 , - 1 , - 1 , 1\right) , \text{sum} \text{=} \text{3,} \text{odd,}$$

$$g \left(x\right) = \left(0 , 0 , 1 , 1 , 2 , 0 , - 1 , 1\right) , \text{sum} \text{=} \text{4,} \text{even,}$$

and take y₀ = g(x). Also,

$$x - \frac{1}{2} = \left(- 0.4 , - 0.4 , 0.3 , 0.8 , 1.7 , - 1.1 , - 1.2 , 0.4\right) ,$$

$$f \left(x - \frac{1}{2}\right) = \left(0 , 0 , 0 , 1 , 2 , - 1 , - 1 , 0\right) , \text{sum} \text{=1} \text{,} \text{odd,}$$

$$g \left(x - \frac{1}{2}\right) = \left(- 1 , 0 , 0 , 1 , 2 , - 1 , - 1 , 0\right) , \text{sum} \text{=0} \text{,} \text{even,}$$

and so

$${y}_{1} = g \left(x - \frac{1}{2}\right) + \frac{1}{2}$$

$$= \left(- 0.5 , 0.5 , 0.5 , 1.5 , 2.5 , - 0.5 , - 0.5 , 0.5\right) .$$

Finally,

$${\left‖x - {y}_{0}\right‖}^{2} = 0.65 , {\left‖x - {y}_{1}\right‖}^{2} = 0.95 ,$$

and it can be concluded that y₀ = g(x) is the closest point to x.

Finding the Closest Point of

$${A}_{n} , {A}_{n}^{∗} , {E}_{7} , \text{and} {E}_{7}^{∗}$$

Algorithm 4—To Find the Closest Point of Aₙ to x:

Step 1: Given x ∈ ℝⁿ⁺¹, compute s = ∑ xᵢ and replace x by

$${x}^{′} = x - \frac{s}{n + 1} \left(1 , 1 , … , 1\right) .$$

Step 2: Calculate

$$f \left({x}^{i}\right) = \left(f \left({{x}^{′}}_{0}\right) , … , f \left({{x}^{′}}_{n}\right)\right)$$

and the deficiency

$$Δ = \sum f \left({{x}^{′}}_{i}\right) .$$

Step 3: Sort the

$${{x}^{′}}_{i}$$

in order of increasing value of

$$δ \left({{x}^{′}}_{i}\right)$$

(defined in Section III). We obtain a rearrangement of numbers 0, 1, ...., n, say i₀, i₁,..., iₙ, such that:

$$- \frac{1}{2} \leq δ \left({{x}^{′}}_{{i}_{0}}\right) \leq δ \left({{x}^{′}}_{{i}_{1}}\right) … \leq δ \left({{x}^{′}}_{{i}_{n}}\right) \leq \frac{1}{2} .$$

Step 4: If Δ=0,ƒ(x′) is the closest point of Aₙ to x.

If Δ>0, the closest point is obtained by subtracting 1 from the components

$$f \left({{x}^{′}}_{{i}_{0}}\right) , … , f \left({{x}^{′}}_{{i}_{Δ - 1}}\right) .$$

If Δ<0, the closest point is obtained by adding 1 to the components

$$f \left({{x}^{′}}_{{i}_{n}}\right) , f \left({{x}^{′}}_{{i}_{n - 1}}\right) , … , f \left({{x}^{′}}_{{i}_{Δ + 1}}\right) .$$

Remarks: As discussed above, ƒ(x) is the closest point of ℤⁿ⁺¹ to x. The procedure described here finds the closest point of Aₙ because it makes the smallest changes to the norm of ƒ(x) needed to make

$$\sum f \left({{x}^{′}}_{i}\right)$$

vanish.

Step 1 projects x onto x′, the closest point of the hyperplane ∑xᵢ = 0. Since Aₙ is by definition contained in this hyperplane, it may be possible to assume that x already lies there, in which case Step 1 can be omitted.

The only substantial amount of computation needed is for the sort in Step 3, which takes O(n log n) steps. Step 3 can be omitted, however, if x is expected to be close to Aₙ. In this case, Δ will be small, and Steps 3 and 4 can be replaced by the following:

Step 3 : If Δ=0, ƒ(x′) is the closest pint of Aₙ to x. If Δ>0, find the Δ components of x′, say

$${{x}^{′}}_{{i}_{n}} , {{x}^{′}}_{{i}_{n - 1}} , … , {{x}^{′}}_{{i}_{n - Δ + 1}} ,$$

for which

$$δ \left({{x}^{′}}_{i}\right)$$

is as small (i.e., as close to

$$- \frac{1}{2}$$

) as possible. The closest point of Aₙ is obtained by subtracting one from the components

$$f \left({{x}^{′}}_{{i}_{0}}\right) , … , f \left({{x}^{′}}_{{i}_{Δ - 1}}\right)$$

of ƒ(x).

If Δ < 0, find the |Δ| components of x′, say

$${x}_{{i}_{n}}^{′} , {x}_{{i}_{n - 1}}^{′} , ... , {x}_{{i}_{n - Δ + 1} ,}^{′}$$

for which

$$δ \left({{x}^{′}}_{i}\right)$$

is as large (i.e., as close to

$$\frac{1}{2}$$

) as possible. The closest point of Aₙ is obtained by adding 1 to the components of

$$f \left({{x}^{′}}_{{i}_{n}}\right) , … , f \left({{x}^{′}}_{{i}_{n - Δ + 1}}\right) \text{of} f \left(x\right) . ,$$

In any case, |Δ| cannot exceed n/2. If Δ is expected to be large, however, the first version of the algorithm is preferable. The closest point of

$${A}_{n}^{∗}$$

can be found using the fact that

$${A}_{n}^{∗}$$

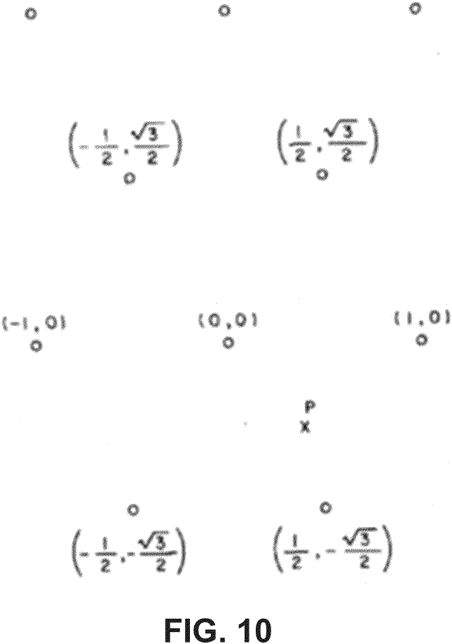

is the union of n + 1 cosets of Aₙ. For example, the hexagonal lattice A₂ is shown in FIG. 10, together with ordinary two-dimensional coordinates (u₁, u₂) for the points. The three-dimensional coordinates (x₀, x₁, x₂) with x₀ + x₁+ x₂= 0 are obtained by multiplying (u₁, u₂) on the right by the matrix:

$$M = \left(\begin{matrix}1 & 0 & - 1 \\ \frac{1}{\sqrt{3}} & \frac{- 2}{\sqrt{3}} & \frac{1}{\sqrt{3}}\end{matrix}\right) .$$

Conversely, the u-coordinates may be obtained from the x-coordinates by:

$$\left({u}_{1} , {u}_{2}\right) = \left({x}_{0} , {x}_{1} , {x}_{2}\right) . \frac{1}{2} {M}^{t r} .$$

For example, the points (0, 0), (1, 0),

$$\left(\sqrt{3} / 2\right) ,$$

$$\left(- 1 / 2 , \sqrt{3} 2\right)$$

have x-coordinates (0, 0, 0), (1, 0, -1), (1, -1, 0), (0, -1, 1), respectively. To find the closest point of Aₙ to the point P with coordinates:

$$\left({u}_{1} , {u}_{2}\right) = \left(0.4 , - 0.4\right) ,$$

first find the x-coordinates of P, which are x = (x₀, x₁, _{X2}) = (0.169, 0.462, -0.631).

Step 1 of the algorithm case be omitted, since x₀ + x₁ + x₂ = 0 holds automatically. Step 2 produces:

$$f \left(x\right) = \left(0 , 0 , - 1\right) ,$$

with deficiency Δ = -1. At Step 3, one obtains:

$$δ \left({x}_{0}\right) = 0.169 < δ \left({x}_{2}\right) = 0.369 < δ \left({x}_{1}\right) = 0.462.$$

At Step 4, 1 is added to ƒ(x₁), obtaining:

$$\left(0 , 1 , - 1\right) ,$$

which is the closest point of A₂. The u-coordinates for this point are:

$$\left(0 , 1 , - 1\right) . \frac{1}{2} {M}^{t r} = \left(\frac{1}{2} , - \frac{\sqrt{3}}{2}\right)$$

(see FIG. 10).

Since A₃ ≅ D₃, Algorithm 2 is preferable to Algorithm 4 for finding the closest point of the face-centered cubic lattice. Finally, E₇ and

$${E}_{7}^{*}$$

can be handled via the algorithm for A₇.

### Decoding the Leech Lattice

In one or more embodiments of the present disclosure, certain lattices can be defined by ‘code formulas’, as follows. Let the standard binary representation of an integer x be:

$$x = {x}_{0} + 2 {x}_{1} + 4 {x}_{2} + ⋯ ,$$

where xₖ is called 2^{k}’s-coefficient, k ≥ 0, and the congruence relations

$$x = {\text{Σ}}_{k} {x}_{k} {2}^{k} \left(m o d {2}^{n}\right) , \text{n} \geq \text{0}$$

may be used to determine the coefficients recursively (particularly if x is negative). Let C₀, C₁ C₂ ... be a set of binary block codes of length N, which must be nested and satisfy certain other conditions to produce a lattice. Then, define A as the set of all integer N-tuples x whose 2^{k′}s-coefficient N-tuple is a code-word in the code Cₖ, for all k ≥ 0. The foregoing can be written symbolically by the ‘code formula’:

$$\text{Λ =} {C}_{0} + 2 {C}_{1} + 4 {C}_{2} + ⋯ .$$

When, as is always the case, the 2^{k′}s-coefficients are allowed to take on any value for k ≥ K —i.e., when Cₖ is the universe (N, N) code for k > K, one may write:

$$\text{Λ=} {C}_{0} + 2 {C}_{1} + ⋯ + {2}^{K - 1} {C}_{2 \text{K} - 1} + {2}^{K} {Z}^{N} ,$$

where Z^{N} is the N-dimensional integer lattice.

One standard definition for the Leech lattice Λ₂₄ expresses it as the union of a sublattice H₂₄ and a coset H₂₄ + a of H₂₄. Here, H₂₄ is a lattice sometimes called the ‘Leech half-lattice,’ which may be defined by the code formula:

$${H}_{24} = \left(24 , 12\right) + 2 \left(24 , 23\right) + 4 {Z}^{24} ,$$

where C₀ = (24,12) is the binary Golay code and C₁ = (24,23) is a single-parity-check code. The translation 24-tuple a may be taken as a = (-3, 1²³)/2.

The Golay code has minimum distance 8 and 759 weight-8 codewords. The minimum squared distance between points in Λ₂₄ or H₂₄ in this representation is

$${d}_{min}^{2} = 8.$$

H₂₄ has 98,256 lattice points of Euclidean norm 8, namely (24·23/2)·4 = 1,104 points with two coordinates of magnitude 2 and 22 of magnitude 0, plus 759·128 = 97,152 points with eight coordinates of magnitude 1 and 16 of zero. Λ₂₄ has 196,560 points of norm 8, namely those of H₂₄ plus 24·4096 = 98,304 points in H₂₄ + α with one coordinate of magnitude 3/2 and 23 coordinates of magnitude ½.

The Voronoi region R_{ν} (0) of a lattice A is the set of points that are at least as close to 0 as to any other point in A; i.e., the Voronoi region is essentially the decision region of a maximum-likelihood decoding algorithm for A (up to the ambiguity involved in resolving ties on the boundary). The packing radius rₘᵢₙ(Λ), or error-correction radius, is the radius of the largest sphere that can be inscribed in R_{ν} (0), and is equal to dₘᵢₙ(Λ)/2, where

$${d}_{m i n}^{2} \left(\text{Λ}\right)$$

is the minimum squared distance between points in A. The kissing number N₀(Λ), or error coefficient, is the number of points on the boundary of R_{ν} (0) with norm

$${r}_{min}^{2} \left(∧\right) ,$$

and is equal to the number of points in Λ of norm

$${d}_{min}^{2} \left(\text{Λ}\right) .$$

For H₂₄,

$${d}_{min}^{2} \left({H}_{24}\right) = 8 , {r}_{min}^{2} \left({H}_{24}\right) = 2 ,$$

and N₀(H₂₄) = 98256 [2]. For Λ₂₄,

$${d}_{min}^{2} \left({\text{Λ}}_{24}\right) = 8 , {r}_{min}^{2} \left({\text{Λ}}_{24}\right) = 2 ,$$

and No(Λ₂₄) =196,560.

Let G₂₄ be the ‘Construction Λ’ lattice consisting of all integer 24-tuples whose ones-coefficient N-tuple is a codeword in the (24,12) binary Golay code; i.e., G₂₄ has the code formula G₂₄ = (24,12) + 2Z²⁴. Then, H₂₄ is a sublattice of G₂₄, and in fact G₂₄ is the union of H₂₄ and a coset H₂₄ + b of H₂₄, where one may take b = (2,0²³). H₂₄ is thus the subset of G₂₄ in which the twos-coefficient 24-tuple has even parity, and H₂₄ + b is the subset with odd parity.

Any soft-decision decoding algorithm for the Golay code may be used as a decoding algorithm for G₂₄ as follows. Given any real 24-tuple r, first find the closest even and odd integers kⱼₒ and kⱼ₁ to each coordinate rⱼ of r. The differences in squared distances, + [(r₁ -kⱼ₀)² - (r₁ - kⱼ₁)² ] /2 = ± [(rⱼ - (kⱼ₀ + kⱼ₁) /2], may be taken as the ‘metrics’ for 0 and 1, respectively, for that coordinate in any soft-decision decoding algorithm for the Golay code. The decoded Golay codeword is then mapped back to kⱼ₀ or kⱼ₁, at the jth coordinate, depending on whether the decoded codeword is 0 or 1 in that coordinate. A maximum-likelihood decoding algorithm for the Golay code that uses between about 700 and 800 operations per 24-tuple on average can be used as a maximum-likelihood decoder for G₂₄; i.e., this algorithm can be used to find the closest point in G₂₄ to any given real 24-tuple r.

A decoding algorithm for H₂₄ can then be specified as follows. Decoding Algorithm 1 (H₂₄): Given any real 24-tuple r representing a received word, first find the closest point x₀ in G₂₄ to r. Check the parity of the twos-coefficient 24-tuple of x₀; if it is even, then it is in H₂₄, so accept it. If it is odd, then change one coordinate of x₀ by ±2 in the coordinate xⱼ₀ where such a change will increase the squared distance (rⱼ - xⱼ₀)² by the least possible amount—i.e., where |rⱼ - xⱼ₀ | is greatest. The resulting point x′₀ has even twos-coefficient parity and is thus in H₂₄.

Additional complexity in Decoding Algorithm 1 beyond decoding G₂₄ can include a parity check and/or a computation and comparison of 24 magnitudes |rⱼ - xⱼ₀|, however this complexity may be negligible.

Decoding Algorithm 1 always maps r into a point in H₂₄ by construction, but not necessarily into the closest point in H₂₄. For example, the 24-tuple x = (- 1, 1⁷, 0¹⁶) is in G₂₄ but not in H₂₄, and the point r = x/2 is at squared distance 2 from both x and the origin 0, which is in all lattices. If the G₂₄ decoder resolves this tie by choosing x, then the parity check will fail. Changing one coordinate by ±2, however, cannot result in the origin 0, which is the closest point in H₂₄, but rather must result in some other point in H₂₄ of norm 8 that is at squared distance 4 from r.

Decoding Algorithm 1 does, however, always map r into the closest point x in H₂₄ when r - x is within the error-correction radius of H₂₄, as shall now be shown. In other words, Decoding Algorithm 1 is a bounded-distance decoding algorithm with the same error exponent as a maximum-likelihood decoder for H₂₄.

Lemma 1: Given a 24-tuple r, if a point x exists in H₂₄ such that ||r - x||² < 2, then Decoding Algorithm 1 decodes r to x.

Proof: Without loss of generality, let x = 0 since if Decoding Algorithm 1 maps r to x, then it maps r + x′ to x + x′; i.e., suppose that ||r||² < 2. Then, since the first step finds the closest point x₀ in G₂₄, x₀ must either be 0 or a point x₀ in G₂₄ of norm ||x₀||² < 8. The only points in G₂₄ with norm less than 8 are 0 and the points with a single nonzero coordinate of magnitude 2. If x₀ is any of the latter points, however, then parity will fail, and 0 will be one of the candidates for the modified point x_{0′}. In fact, 0 must then be chosen because any other candidate point is in H₂₄, therefore has norm at least 8, and thus cannot be closer to r than 0. Hence all points r with ||r||² < 2 map to 0.

The set of all points r that map to 0 is called the decision region R₁(0) of Decoding Algorithm 1. By the translation property, the set of all points that map to any lattice point x is R₁ (x) = R₁(0) + x. Lemma 1 shows that R₁(0) contains all points of norm less than 2. Since spheres of radius 2 drawn around the points of H₂₄ must touch, there must be points of norm 2 on the boundary of R₁(0). The number of points on the boundary of R₁(0) with norm ||r||² = 2 is the effective error coefficient N_{0,eff} of Decoding Algorithm 1. Lemma 2 shows that Decoding Algorithm 1 approximately doubles the effective error coefficient of H₂₄.

Lemma 2: The effective error coefficient of Decoding Algorithm 1 is N_{0,eff} = 98,256 + 97,152 = 195,408.

Proof: In addition to the 98,256 points in H₂₄ of norm 8, there are 759.128 = 97,152 points of norm 8 with eight coordinates of magnitude 1 and 16 of 0 that are in G₂₄ but not in H₂₄ (those with odd twos-coefficient parity). If the G₂₄ decoder decodes r to any of these points in the first step of Decoding Algorithm 1, the second step cannot yield x′₀ = 0.

To decode the Leech lattice Λ₂₄, Decoding Algorithm 1 may be applied twice to the two cosets of H₂₄ of which Λ₂₄ is the union.

Decoding Algorithm 2 (Λ₂₄): Given any real 24-tuple r, apply Decoding Algorithm 1 to r to find a point x₀ in H₂₄; also, Decoding Algorithm 1 to r - a to find a point x₁ in H₂₄ whose translate x₁ + a is in the coset H₂₄ + a. Compute the squared distances ||r - x₀||² and ||r - x₁ + a)||², and choose x₁ or x₁ + a according to which distance is smaller.

The complexity of Decoding Algorithm 2 is not much more than twice that of Decoding Algorithm 1 since the complexity of the translations of r and x₁ by a and the computation and comparison of the two squared distances is small compared to the complexity of Golay decoding.

It can be shown that Decoding Algorithm 2 is a bounded-distance decoding algorithm that achieves the error-correction radius of Λ₂₄ and increases the effective error coefficient by a factor of only about 1.5. Thus, the effective signal-to-noise ratio required by Decoding Algorithm 2 is only about 0.1 dB worse than that of maximum-likelihood decoding if the noise is Gaussian and the desired error rate is of the order of 10⁻⁶.

Theorem 1: Given a 24-tuple r, if there is a point x in Λ₂₄ such that ||r - x||², then Decoding Algorithm 2 decodes r to x.

Proof: If x is in H₂₄, then by Lemma 1, Decoding Algorithm 1 applied to r yields x; if x is in H₂₄ + a, then x - a is in H₂₄ and thus by Lemma 1, Decoding Algorithm 1 applied to r -a yields x - a. Since

$${d}_{min}^{2} \left({\text{Λ}}_{24}\right) = 8 ,$$

there can be only one point x in Λ₂₄ such that ||r - x||² < 2. If either of the two trial decodings finds such a point, it must be chosen as the closest point.

Theorem 2: The effective error coefficient of Decoding Algorithm 2 is N₀,_{eff} = 196,560 + 97,152 = 293,712.

Proof: The effective error coefficient is the number of points on the boundary of the decision region R₂(0) of norm 2, which is the same as the number of points x in G₂₄ or G₂₄ + a of norm 8 that are in Λ₂₄ or cannot be modified to 0 by a change of ±2 in one coordinate. This includes the 196,560 points in Λ₂₄ of norm 8 and also the 97,152 points of norm 8 that are in G₂₄ but not H₂₄ that were mentioned in the proof of Lemma 2. Any point in G₂₄ + a = G₂₄ + (½)²⁴ can be modified to a point in H₂₄ + a by a change of ±2 in the first coordinate, so that there are no further points of this type.

### Shaping Region vs. Shape Gain Tradeoffs

In some embodiments, when selecting the boundary of a signal constellation used for data transmission, one tries to minimize the average energy of the constellation for a given number of points from a given packing. The reduction in the average energy per two dimensions due to the use of a region

$$C$$

as the boundary instead of a hypercube, is called the shaping gain γₛ of

$$C .$$

The price to be paid for shaping involves an increase in the factor constellation-expansion ratio (CERₛ), an increase in the factor peak-to-average-power ratio (PAR), and an increase in the addressing complexity. There exists a tradeoff between γₛ and CERₛ, PAR, however as discussed herein, an N-dimensional shaping region may be selected having a structure that simultaneously optimizes the tradeoffs, as discussed below.

In one or more embodiments of the present disclosure, the integral of a function of the general form

$$F \left({X}_{0}^{2} + ... + {X}_{N - 1}^{2}\right)$$

over a final region

$${A}_{N}$$

is calculated as:

$$\begin{matrix}{\int }_{{A}_{N}} F \left({X}_{0}^{2} + ⋯ + {X}_{N - 1}^{2}\right) d {X}_{0} ⋯ d {X}_{N - 1} \\ \\ = {\left(π {R}_{2}^{2}\right)}^{n} {\sum }_{k = 0}^{\left[β\right]} {\left(- 1\right)}^{k} {C}_{n}^{k} \frac{{\left(β - k\right)}^{n}}{\left(n - 1\right) !} \\ \\ ∗ {\int }_{0}^{1} F \left({R}_{2}^{2} \left[\left(β - k\right) τ + k\right]\right) {τ}^{n - 1} d τ .\end{matrix}$$

This integral is used to calculate the volume and the second moment of the

$${A}_{N}$$

region. The results, together with

$$V \left({C}_{2}\right) = π {R}_{2}^{2} \text{and} {E}_{p} \left({C}_{2}\right) = {R}_{2}^{2} , \text{where} V \left({C}_{2}\right)$$

where is the volume of shaping region

$${C}_{2}$$

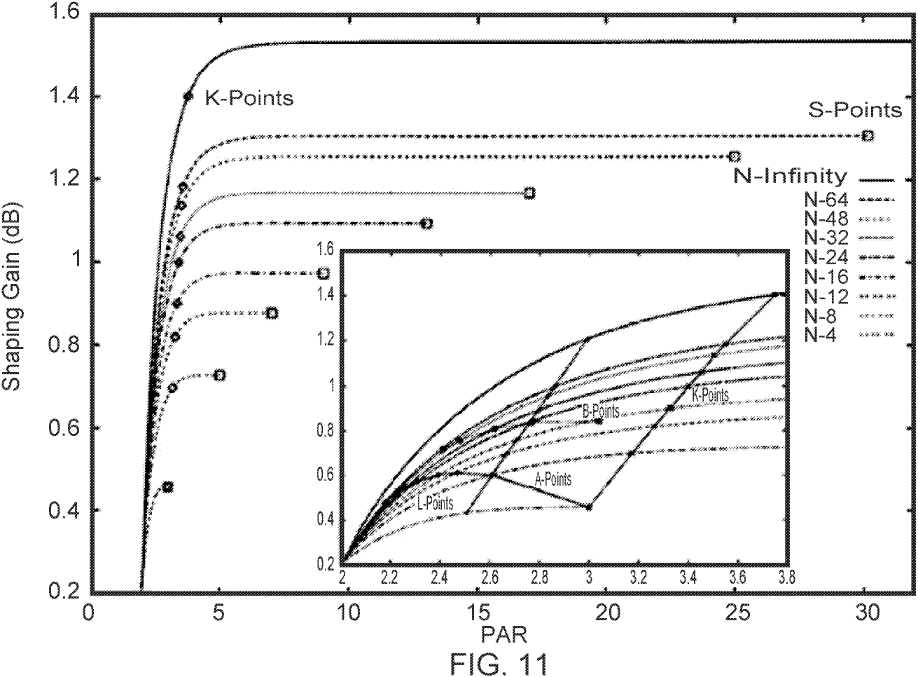

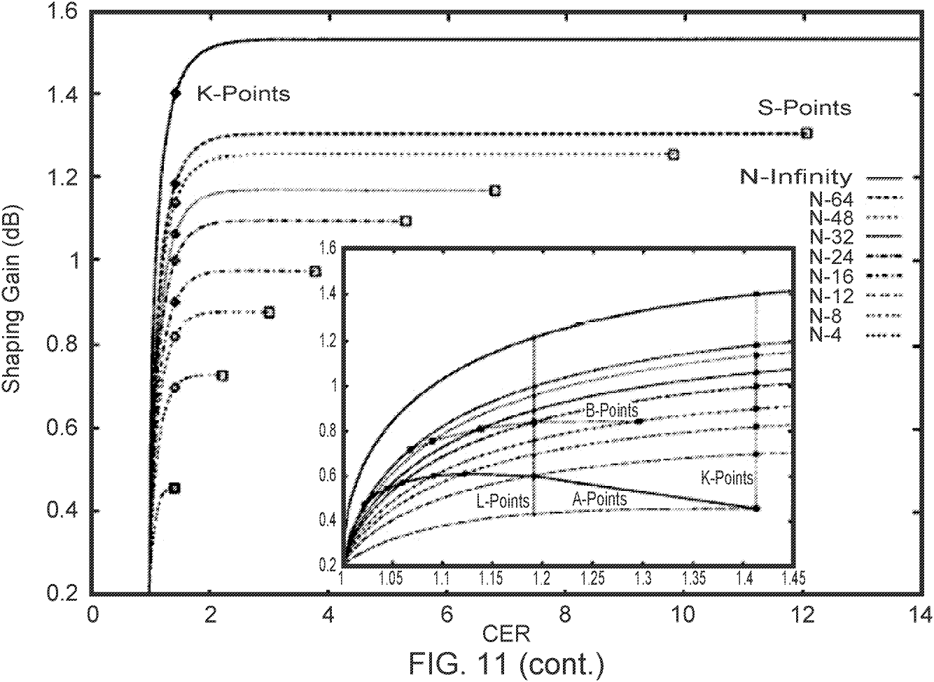

and R₂ is the radius, can be used to compute γₛ, CERₛ, and PAR. FIG. 11 shows the corresponding tradeoff curves for different values of N. As N → ∞, the induced probability distribution along 2-D subspaces of the A_{N} region tends to a truncated Gaussian distribution; a consequence of the optimality of these regions.

The expression ψ = β/n(n = N/2) can be used as the normalized parameter for the

$${A}_{N}$$

region. The complete notation for the region is

$${A}_{N} \left(ψ\right) .$$

For ψ = 1/n(β = 1, R_{N} = R₂), the spherical region ℓ₂ (R_{N}) is obtained. This case corresponds to the final point on the tradeoff curves. For

$$1 / n < φ < 1 \left(1 < β < n , {R}_{2} < {R}_{N} < \sqrt{n {R}_{2}}\right) ,$$

by increasing ψ, one moves along the curves towards their initial parts. Finally, for

$$υ = 1 \left(β = n , {R}_{N} = \sqrt{n} {R}_{2}\right) ,$$

one has

$${A}_{N} = {\left\{{l}_{2} \left({R}_{2}\right)\right\}}^{n} .$$

This results in the starting point on the tradeoff curves. The two cases of 0 < ψ < 1/n and ψ > 1 results in the regions

$${I}_{N} \left(\sqrt{n υ} {R}_{2}\right)$$

and

$${\left(\left({L}_{2} \left({R}_{2}\right)\right)\right\}}^{n} ,$$

respectively.

Referring to FIG. 11, it can be seen that, in general, the initial parts of the optimum tradeoff curves have a steep slope. This means that an appreciable portion of the maximum shaping gain, corresponding to a spherical region, can be achieved with a small value of CERₛ, PAR. Table I (below) contains a set of points from the optimum tradeoff curves. These are the points marked on the curves in FIG. 11.

TABLE I

A Set of Points from the Optimum Tradeoff Curves of FIG. 11

| | | A | | | B | | | L | | | K | | | S | |
|---|---|---|---|---|---|---|---|---|---|---|---|---|---|---|---|
| N | CERₛ | PAR | γₛdB | CERₛ | PAR | γₛ dB | CERₛ | PAR | γₛ dB | CERₛ | PAR | γₛ dB | CERₛ | PAR | γₛ dB |
| 4 | 1.41 | 300 | 0.46 | --- | --- | --- | --- | --- | --- | L41 | 3.00 | 0.46 | 1.41 | 3.0 | 0.46 |
| 8 | 1.19 | 2.60 | 0.60 | 1.68 | 3.76 | 0.72 | 1.19 | 2.60 | 0.60 | 1.41 | 3.19 | 0.70 | 2.21 | 5.0 | 0.73 |
| 12 | 1.12 | 2.47 | 0.61 | 1.41 | 3.26 | 0.82 | 1.19 | 2.68 | 0.70 | 1.41 | 3.26 | 0.82 | 2.99 | 7.0 | 0.88 |
| 16 | 1.09 | 2.39 | 0.60 | 1.30 | 3.04 | 0.85 | 1.19 | 2.71 | 0.76 | 1.41 | 3.33 | 0.90 | 3.76 | 9.0 | 0.98 |
| 24 | 1.06 | 2.31 | 0.57 | 1.19 | 2.76 | 0.84 | 1.19 | 2.76 | 0.84 | 1.41 | 3.42 | 1.00 | 5.29 | 13.0 | 1.10 |
| 32 | 1.04 | 2.26 | 0.55 | 1.14 | 2.62 | 0.81 | 1.19 | 2.80 | 0.89 | 1.41 | 3.45 | 1.06 | 6.80 | 1 | 1.17 |
| 48 | 1.03 | 2.22 | 0.52 | 1.09 | 2.48 | 0.76 | 1.19 | 2.83 | 0.96 | 1.41 | 3.51 | 1.14 | 9.80 | 25.0 | 1.26 |
| 64 | 1.02 | 2.18 | 0.48 | 1.07 | 2.41 | 0.72 | 1.19 | 2.86 | 1.00 | 1.41 | 3.53 | 1.18 | 12.04 | 33.0 | 1.31 |
| 128 | 1.01 | 2.12 | 0.41 | 1.03 | 2.27 | 0.61 | 1.19 | 2.93 | 1.08 | 1.41 | 3.65 | 1.27 | 24.67 | 65.0 | 1.40 |
| ∞ | 1.00 | 2.00 | 0.20 | 1.00 | 1.00 | 0.20 | 1.19 | 3.00 | 1.20 | 1.41 | 3.75 | 1.40 | ∞ | ∞ | 1.53 |

The S-points correspond to a spherical region and achieve the maximum shaping gain in a given dimensionality. The K-points correspond to rₛ = N/4 (CERₛ = (2)^{½} = 1.41). They achieve almost all of the shaping gain of the S-points, but with a much lower value of CERₛ, PAR. The L-points correspond to rₛ = N/8 (CERₛ = (2)^{½} = 1.19). They achieve a significant γₛ with a very low CERₛ, PAR. The B-points correspond to rₛ = 3 (CERₛ = (8)^{2/N}). The A-points correspond to the addressing scheme based on the lattice

$${D}_{n}^{*}$$

and result in rₛ = 1 (CERₛ = (2)^{2/N}). For N = 4, this point corresponds to a spherical region.

From FIG. 11, it can be seen that for N around 12, the A-points with rₛ = 1 are located near the knee of the optimum tradeoff curves. For larger dimensionalities, specifically for N> 16, they are closer to the initial parts of the curves. This means that for N > 16, one bit of redundancy per N dimensions is too small. A solution in a space of dimensionality N = n′ x N′ (N′ even) is to use the lattice

$${D}_{n}^{*} , n = {N}^{′} / 2$$

to shape the N′ - D subspaces and then achieve another level of shaping on the n′ = N/N′-fold Cartesian product of these subspaces. This is one example of the application of a multilevel shaping/addressing scheme.

More generally, consider an

$${A}_{N} \left(ψ\right)$$

region. This region has an

$${A}_{N} \left(N ψ / N ′\right)$$

region along each of its constituent N′ — D (N′ even) subspaces. The basic idea is that the

$${A}_{N} \left(N ψ / N ′\right)$$

subregions can be modified such that the complexity of the addressing in the N-D space is decreased while the overall suboptimality is small. Specifically, in some of our schemes, 1) the

$${A}_{N} \left(N ψ / N ′\right)$$

region is replaced by the region

$${A}_{N} \left(1 / 2\right) ,$$

and/or 2) this region is partitioned into a finite number of energy shells, and then the Cartesian product of the N′ -D subspaces can be shaped.

Additional details regarding multi-dimensional signal constellations, signal modulation, and other methods / techniques compatible with embodiments of the present disclosure can be found in the following references, the entire contents of each of which is incorporated by reference herein for all purposes and appended hereto as Appendices A-D, respectively: G. R. Lang and F. M. Longstaff, “A Leech lattice modem,” in IEEE Journal on Selected Areas in Communications, vol. 7, no. 6, pp. 968-973, Aug. 1989, doi: 10.1109/49.29618 (Appendix A); European Patent Number EP1608081, issued May 6, 2009 and titled “Apparatus and Method for Space-Frequency Block Coding/Decoding in a Communication System” (Appendix B); Zamir, Ram, “Lattice Coding for Signals and Networks,” Cambridge University Press, 2014 (Appendix C); and Hao, W. & Zhang, J.-Q & Song, H.-B (2014), A lattice based approach to the construction of multi-dimensional signal constellations, Tien Tzu Hsueh Pao/Acta Electronica Sinica, 42, 1672-1679. 10.3969/j.issn.0372-2112.2014.09.002 (Appendix D).

Additional details regarding lattice constructions and lattice encoding compatible with embodiments of the present disclosure can be found in Blake, Ian, “The Leech Lattice as a Code for the Gaussian Channel,” Information and Control 19, 66-74 (1971); J. Choi, Y. Nam and N. Lee, “Spatial Lattice Modulation for MIMO Systems,” in IEEE Transactions on Signal Processing, vol. 66, no. 12, pp. 3185-3198, 15 Jun. 15, 2018, doi: 10.1109/TSP.2018.2827325; G. D. Forney, “Coset codes. I. Introduction and geometrical classification,” in IEEE Transactions on Information Theory, vol. 34, no. 5, pp. 1123-1151, Sept. 1988, doi: 10.1109/18.21245; G.D. Forney, “Coset codes. II. Binary lattices and related codes,” in IEEE Transactions on Information Theory, vol. 34, no. 5, pp. 1152-1187, Sept. 1988, doi: 10.1109/18.21246; J. Conway and N. Sloane, “A fast encoding method for lattice codes and quantizers,” in IEEE Transactions on Information Theory, vol. 29, no. 6, pp. 820-824, November 1983, doi: 10.1109/TIT.1983.1056761; U.S. Patent Number 9,692,456, issued Jun. 27, 2017 and titled “Product Coded Modulation Scheme Based on E8 Lattice and Binary and Nonbinary Codes”; U.S. Patent Number 7,036,071, issued Apr. 25, 2006 and titled “Practical Coding and Metric Calculation for the Lattice Interfered Channel”; G. Forney, R. Gallager, G. Lang, F. Longstaff and S. Qureshi, “Efficient Modulation for Band-Limited Channels,” in IEEE Journal on Selected Areas in Communications, vol. 2, no. 5, pp. 632-647, September 1984, doi: 10.1109/JSAC.1984.1146101; A. K. Khandani and P. Kabal, “An efficient block-based addressing scheme for the nearly optimum shaping of multidimensional signal spaces,” in IEEE Transactions on Information Theory, vol. 41, no. 6, pp. 2026-2031, Nov. 1995, doi: 10.1109/18.476330; S. Stem and R. F. H. Fischer, “Lattice-Reduction-Aided Precoding for Coded Modulation over Algebraic Signal Constellations,” WSA 2016; 20th International ITG Workshop on Smart Antennas, 2016, pp. 1-8; and G. D. Forney and G. Ungerboeck, “Modulation and coding for linear Gaussian channels,” in IEEE Transactions on Information Theory, vol. 44, no. 6, pp. 2384-2415, Oct. 1998, doi: 10.1109/18.720542, the entire contents of each of which is incorporated by reference herein for all purposes.

Additional details regarding lattice decoding algorithms compatible with embodiments of the present disclosure can be found in: D. J. Costello and G. D. Forney, “Channel coding: The road to channel capacity,” in Proceedings of the IEEE, vol. 95, no. 6, pp. 1150-1177, June 2007, doi: 10.1109/JPROC.2007.895188; J. Conway and N. Sloane, “Fast quantizing and decoding and algorithms for lattice quantizers and codes,” in IEEE Transactions on Information Theory, vol. 28, no. 2, pp. 227-232, March 1982, doi: 10.1109/TIT.1982.1056484; and G. D. Forney, “A bounded-distance decoding algorithm for the Leech lattice, with generalizations,” in IEEE Transactions on Information Theory, vol. 35, no. 4, pp. 906-909, July 1989, doi: 10.1109/18.32173, the entire contents of each of which is incorporated by reference herein for all purposes.

Additional details regarding boundary selection for signal constellations in data transmission compatible with embodiments of the present disclosure can be found in: A. K. Khandani and P. Kabal, “Shaping multidimensional signal spaces. I. Optimum shaping, shell mapping,” in IEEE Transactions on Information Theory, vol. 39, no. 6, pp. 1799-1808, Nov. 1993, doi: 10.1109/18.265491; and A. K. Khandani and P. Kabal, “Shaping multidimensional signal spaces. II. Shell-addressed constellations,” in IEEE Transactions on Information Theory, vol. 39, no. 6, pp. 1809-1819, Nov. 1993, doi: 10.1109/18.265493, the entire contents of each of which is incorporated by reference herein for all purposes.

Example applications of lattice constellation compatible with embodiments of the present disclosure can be found in: U.S. Pat. No. 9,172,578, issued Oct. 27, 2015 and titled “High Speed Transceiver Based on Embedded Leech Lattice Constellation”; U.S. Pat. No. 8,989,283, issued May 24, 2015 and titled “High Speed Transceiver Based on Concatenates of a Leech Lattice with Binary and Nonbinary Codes”; G. Ungerboeck, “Channel coding with multilevel/phase signals,” in IEEE Transactions on Information Theory, vol. 28, no. 1, pp. 55-67, January 1982, doi: 10.1109/TIT.1982.1056454; and U. Wachsmann, R. F. H. Fischer and J. B. Huber, “Multilevel codes: theoretical concepts and practical design rules,” in IEEE Transactions on Information Theory, vol. 45, no. 5, pp. 1361-1391, July 1999, doi: 10.1109/18.771140, the entire contents of each of which is incorporated by reference herein for all purposes.

Implementations of the various techniques described herein may be implemented in digital electronic circuitry, or in computer hardware, firmware, software (executed or stored in hardware), or in combinations of them. Implementations may be implemented as a computer program product, i.e., a computer program tangibly embodied, e.g., in a machine-readable storage device (computer-readable medium, a non-transitory computer-readable storage medium, a tangible computer-readable storage medium, etc.), for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a liquid crystal display (LCD or LED) monitor, a touchscreen display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A non-transitory, processor-readable medium storing instructions that, when executed by a processor, cause the processor to:
receive a bit string;
identify a plurality of binary strings based on the bit string;
map each binary string from the plurality of binary strings to an element from a plurality of elements of a lattice-based signal constellation, without using a lookup table;
identify a plurality of real-valued points from the plurality of elements based on the mapping; and
cause transmission of a signal having a modulation based on the plurality of real-valued points.

2. The non-transitory, processor-readable medium of claim 1, wherein the plurality of real-valued points represents a plurality of in-phase/quadrature (I/Q) points.

3. The non-transitory, processor-readable medium of claim 1, wherein each real-valued point from the plurality of real-valued points is associated with a point within a fundamental region of a Voronoi cell of the lattice-based signal constellation.

4. The non-transitory, processor-readable medium of claim 1, wherein each real-valued point from the plurality of real-valued points is associated with a point within a shifted fundamental region of a Voronoi cell of the lattice-based signal constellation.

5. The non-transitory, processor-readable medium of claim 1, wherein the plurality of elements is associated with a quotient of a first lattice and a second lattice, the second lattice being a copy of the first lattice scaled by a positive integer.

6. The non-transitory, processor-readable medium of claim 1, wherein each binary string from the plurality of binary strings is a binary expansion of an integer of the quotient ℤⁿ/mℤⁿ, where ℤⁿ is an n-dimensional vector of integers, n is a positive integer, and m is a positive integer.

7. The non-transitory, processor-readable medium of claim 1, further storing instructions that, when executed by the processor, cause the processor to at least one of upsample the plurality of real-valued points, filter the plurality of real-valued points, drive the plurality of real-valued points to carrier, or send the plurality of real-valued points through a digital-to-analog converter, prior to causing transmission of the signal.

8. A method, comprising:
receiving, at a processor, a bit string;
identifying, via the processor, a plurality of binary strings based on the bit string;
mapping, via the processor, each binary string from the plurality of binary strings to an element from a plurality of elements of a lattice-based signal constellation, without using a rectangular shaping region;
identifying, via the processor, real-valued points from the plurality of elements based on the mapping; and
causing transmission of a signal having a modulation based on the real-valued points.

9. The method of claim 8, wherein the mapping of each binary string from the plurality of binary strings to an element from the plurality of elements of the lattice-based signal constellation is not based on lattice coding.

10. The method of claim 8, wherein the mapping of each binary string from the plurality of binary strings to an element from the plurality of elements of the lattice-based signal constellation is not based on redundant lattice points.

11. The method of claim 8, wherein the real-valued points represent in-phase/quadrature (I/Q) points.

12. The method of claim 8, wherein the plurality of elements is associated with a quotient of a first lattice and a second lattice, the second lattice being a copy of the first lattice scaled by a positive integer.

13. The method of claim 8, wherein each real-valued point from the real-valued points is associated with a point within a fundamental region of a Voronoi cell of the lattice-based signal constellation.

14. The method of claim 8, wherein each real-valued point from the real-valued points is associated with a point within a shifted fundamental region of a Voronoi cell of the lattice-based signal constellation.

15. The method of claim 8, wherein each binary string from the plurality of binary strings is a binary expansion of an integer of the quotient ℤⁿ/mℤⁿ, where ℤⁿ is an n-dimensional vector of integers, n is a positive integer, and m is a positive integer.

16. The method of claim 8, further comprising at least one of upsampling the real-valued points, filtering the real-valued points, driving the real-valued points to carrier, or sending the real-valued points through a digital-to-analog converter, prior to causing transmission of the signal.

17. A non-transitory, processor-readable medium storing instructions that, when executed by a processor, cause the processor to:
receive, at a processor and from a transmitter, a signal encoding a bit string;
identify, via the processor and based on the signal and a closest vector algorithm, a point of an n-dimensional lattice associated with the signal;
multiply, via the processor, the point of the n-dimensional lattice by an inverse of a basis of the n-dimensional lattice, to identify an element from a plurality of elements of an n-dimensional matrix ℤⁿ associated with the signal; and
recover bits based on the signal, via the processor, by reducing components of the signal modulo m, to produce an element of a quotient ℤⁿ/mℤⁿ, where n is a positive integer, and m is a positive integer.

18. The non-transitory, processor-readable medium of claim 17, further comprising instructions that, when executed by the processor, cause the processor to perform at least one of synchronization or equalization of the signal prior to identifying the point of an n-dimensional lattice associated with the signal.

19. The non-transitory, processor-readable medium of claim 17, wherein the point is a first point, the media further comprising instructions that, when executed by the processor, cause the processor to:
identify, via the processor, an ambiguity associated with the quotient ℤⁿ/mℤⁿ; and in response to identifying the ambiguity:
select, via the processor, a set of faces of a fundamental region of the n-dimensional lattice, and
identify, via the processor and based on the set of faces of the fundamental region of the n-dimensional lattice, a second point of the n-dimensional lattice associated with the signal,
the instructions to recover the bits including instructions to recover the bits further based on the second point.

20. The non-transitory, processor-readable medium of claim 17, wherein the point is a first point, the media further comprising instructions that, when executed by the processor, cause the processor to:
identify, via the processor, an ambiguity associated with the quotient ℤⁿ/mℤⁿ; and in response to identifying the ambiguity:
center a fundamental region of the n-dimensional lattice around a second point of the n-dimensional lattice that is distanced from an origin of the n-dimensional lattice, such that the plurality of elements of the n-dimensional matrix ℤⁿ do not lie on a surface of the fundamental region.
